(19) United States
(12) Patent Application Publication
(10) Pub. No.: US 2008/0238448 A1
(43) Pub. Date: Oct. 2, 2008

(54) Capacitance sensing for percussion instruments and methods therefor

(75) Inventors: Michael T. Moore, Milpitas, CA (US); Marcus Kramer, San Diego, CA (US)

Correspondence Address: Haverstock & Owens- Cypress, 162 North Wolfe Road, Sunnyvale, CA, 94086, US

(73) Assignee: Cypress Semiconductor Corporation

(21) Appl. No.: 11/731,240

(22) Filed: Mar. 30, 2007

(51) Int. Cl. G10H 3/14

(52) U.S. Cl. 324/686

(57) ABSTRACT

A percussion instrument data generating system can include a plurality of capacitance sensors coupled to the at least a first surface. A controller section can includes a plurality of switches for selectively connecting each capacitance sensor to a sense node. A capacitance sense circuit can be coupled to the common sense node and can measures a capacitance presented at the common sense node. An encoder section that generates a position value for a sensed input event based that varies according to which capacitance sensor detects the input event.

### TECHNICAL FIELD

The present invention relates generally to musical instruments, and more particularly to electronic percussion instruments and/or percussion input devices.

### BACKGROUND OF THE INVENTION

The detection of percussive events can serve as useful input signals for instruments and systems. For example, conventional electronic percussion systems are know that can be used in place of conventional acoustic percussion instruments. In addition to musical instrument applications, the detection of percussive events can be a desirable feature for controller objects, such as those utilized as gaming inputs to personal computer (PC) based, console based and/or portable gaming systems.

Conventional electronic pad based percussion systems are known. Many such conventional approaches can rely on piezoelectric sensors that can convert the pressure of a percussive event into an electronic signal. Many such conventional systems only determine when a playing surface is struck, and not where such an event occurs.

U.S. Pat. No. 4,852,443 by Duncan et al. and issued on Aug. 1, 1989 discloses a capacitive pressure-sensing method and apparatus having a drum-like application. The drum-like application can track changes in capacitance to a pad by measuring a degree of alternate current (AC) current flow.

A drawback to conventional approaches, like those described above can be the manufacturing costs involved. In addition, such devices can also have an undesirable high degree of complexity when it comes to the manufacturing of systems and devices employing such conventional approaches.

### BRIEF DESCRIPTION OF THE DRAWINGS

FIGS. 1A and 1B show a percussion instrument according to a first embodiment of the present invention.

FIG. 2 shows a percussion instrument according to a second embodiment of the present invention.

FIG. 3 shows a percussion instrument according to a third embodiment of the present invention.

FIG. 4 shows a percussion instrument according to a fourth embodiment of the present invention.

FIG. 5 shows a percussion instrument according to another embodiment of the present invention.

FIG. 6 shows a percussion instrument according to yet another embodiment of the present invention.

FIG. 7 is a side cross sectional view showing a materials that can be included in percussion instruments like those shown in FIGS. 5 and 6.

FIG. 8 is a diagram showing a sense operation according to one type of capacitance sensing that can be included in the embodiments.

FIG. 9 is a diagram showing a sense operation according to another type of capacitance sensing that can be included in the embodiments.

FIGS. 10A and 10B are diagrams showing a sense operation according to yet another type of capacitance sensing that can be included in the embodiments.

FIG. 11A is a diagram of a capacitance sensor that can be included in the embodiments. FIGS. 11B to 11D are diagrams showing wiring arrangements for capacitance sensors according to various embodiments.

FIG. 12 is a block schematic diagram of a capacitance sensing system that can be included in the embodiments.

FIG. 13 is a block schematic diagram of another capacitance sensing system that can be included in the embodiments.

FIG. 14 is a block schematic diagram of yet another capacitance sensing system that can be included in the embodiments.

FIG. 15 is a flow diagram of a capacitance sense method that can be executed by a capacitance sense system like that shown in FIGS. 12, 13 and/or 14.

FIG. 16 is a block schematic diagram of a capacitance sensor array that can be included in the embodiments.

FIG. 17A is a block schematic diagram of a system according to an embodiment.

FIG. 17B shows an input indication approach according to an embodiment.

FIG. 18 shows one approach to reprogramming capacitance sensor grouping.

FIGS. 19A to 19C show examples of capacitance sensor arrays can be reprogrammed into different group configurations.

FIG. 20 shows another approach to reprogramming capacitance sensor grouping.

FIGS. 21A and 21B show examples of how particular capacitance sensor arrays can be reprogrammed into different group configurations.

FIGS. 22A and 22B show the generation of a sound value according to embodiments.

FIG. 23 shows the generation of a sound activation value from a capacitance sensor array according to an embodiment.

FIG. 24 shows a system that includes a display for indicating detected input events of an instrument according to one embodiment.

FIG. 25 shows the storage of input events with corresponding times of such events, according to one embodiment.

FIG. 26 is a timing diagram showing the alteration of a previously generated sound value according to an embodiment.

FIG. 27 shows an encoding circuit that can be included in the embodiments.

FIG. 28 shows a sound generation circuit according to an embodiment.

FIG. 29 is a block schematic diagram of a controller according to one embodiment.

FIGS. 30 to 34 are block schematic diagrams showing various system embodiments.

### DETAILED DESCRIPTION

Various embodiments of the present invention will now be described in detail with reference to a number of drawings. The embodiments show systems, instruments, and processing methods that can be used in the generation of data values in response to percussive events.

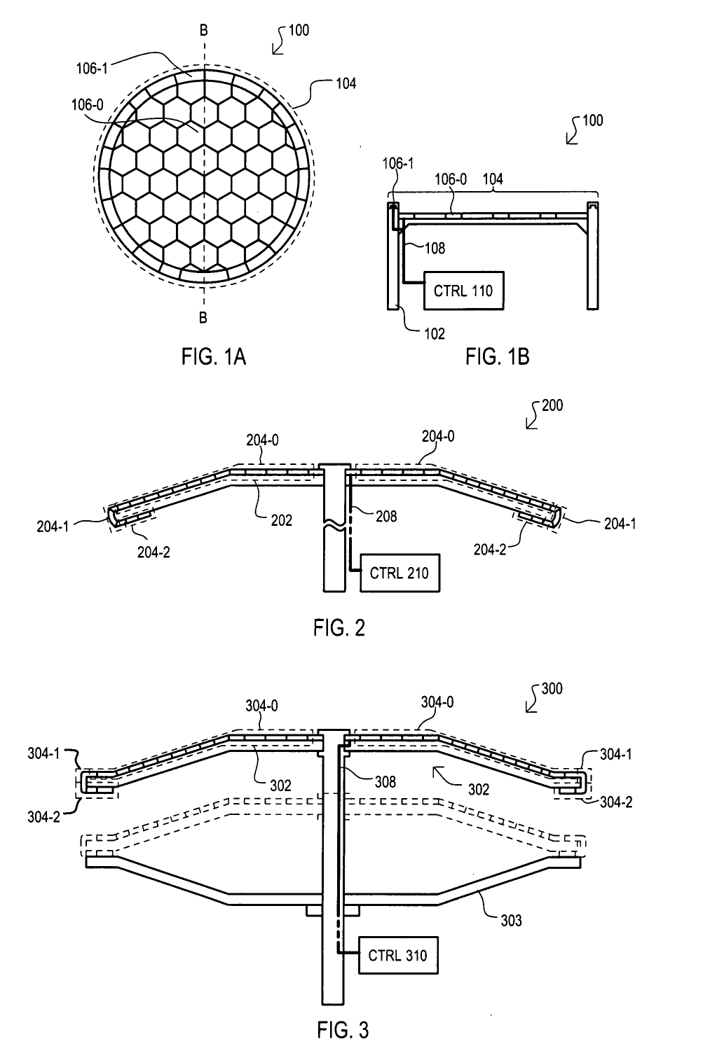

A percussion instrument according to a first embodiment is shown in a top view in FIG. 1A and a side cross sectional view in FIG. 1B, and designated by the general reference character 100. The view of FIG. 1B is taken along line B-B of FIG. 1A.

An instrument 100 can have the same general shape of a known percussion instrument, and in the very particular example of FIGS. 1A and 1B can have the shape of a “tom” type drum. An instrument 100 can include a body 102 and a playing surface 104 supported by the body 102, and a controller assembly 110.

A playing surface 104 can include one or more capacitance sensors that can provide a capacitance that can vary in response to a percussive event. In the example of FIGS. 1A and 1B, instrument 100 can include membrane sensors (one shown as 106-0) that can occupy locations of a membrane (i.e., skin or drumhead) in a conventional acoustic drum, as well as rim sensors (one shown as 106-1) that can occupy locations of a rim in a conventional acoustic drum. Capacitance sensors (e.g., 106-0 and 106-1) can be connected by a signal path 108 to inputs of a controller assembly 110.

It is understood that while FIGS. 1A and 1B show a particular shape, number, and tiling of capacitance sensors (e.g., 106-0 and 106-1), such an arrangement is intended to serve as but one example of possible variations.

A controller assembly 110 can include capacitance sensing and processing circuits that generate sound, position and/or other indications in response to a percussive event on playing surface 104. A controller assembly 110 is preferably attached to body 102, but can be located remote from a body 102. A controller assembly 110 can sense a capacitance for multiple capacitance sensors in a multiplexing fashion, selectively connecting different capacitance sensors to a common sense node. Such an arrangement can provide an advantageously a compact input sensing circuit, as compared to conventional arrangements that can include a dedicated processing circuit for each capacitance sensor.

It is noted that a percussive event can vary between applications. For example, in some applications a percussion event can be the striking of the playing surface with an object, such as a drumstick, mallet, or brush, but in other arrangements could include the tapping of a finger. Differentiation between such events can be established by setting different threshold values utilized in a capacitance sensing method. Further, and as will be described below, percussive events can be filtered according to various criteria to determine a valid input event, including but not limited to, a speed at which a object approaches/contacts a playing surface and/or a force with which an object strikes a playing surface.

As will be described in more detail below, outputs from an instrument, such as that shown in FIGS. 1A/1B and various embodiments described below, can take various forms. As but a few of the many possible examples, outputs can be an audio signal in analog or digital form. Alternatively, outputs can be in a predetermined digital music format, such as that of the musical instrument digital interface (MIDI). Outputs can also be in a format suitable controller applications, such as input devices to personal computers (PC), gaming consoles, or like applications.

In this way, a capacitance value for multiple sensors on a playing surface of a percussion instrument can be monitored for percussive events.

While FIGS. 1A and 1B show one particular instrument shape, this should not be construed as limiting the invention thereto. Alternate embodiments can take various other arbitrary shapes. A few of the many possible examples are shown in FIGS. 2-5.

Referring now to FIG. 2, a percussion instrument according to a second embodiment is shown in a side cross sectional view, and designated by the general reference character 200. Percussion instrument 200 can include some of the same general sections as FIGS. 1A and 1B, thus like sections are referred to by the same reference character but with the first digit being a “2” instead of a “1”.

FIG. 2 shows an instrument having the shape of a cymbal, such as a “crash” or “ride” cymbal. As is well known, a typical cymbal has a disc-like shape with a raised bell area in a central region. The embodiment of FIG. 2 can differ from that of FIGS. 1A and 1B in that it can include multiple playing surfaces on different sides of the instrument.

In the very particular example of FIG. 2, instrument 200 can include a first playing surface 204-0 formed on a top side of the cymbal shape, a second playing surface 204-1 formed on an edge of the cymbal shape, and a third playing surface 204-2 formed on a bottom side of the cymbal shape. Each different playing surface (204-0 to 204-2) can include one or more capacitance sensors, and can provide different inputs to a controller assembly 210. Thus, a percussive event can be distinguishable according to surface of an object.

As but a few examples, single or multiple percussive events on any of playing surfaces (204-0 or 204-2) can result in a different sound value being encoded or generated. Further, simultaneous percussive event on two such playing surfaces, can result in a different type of sound event. Even more particularly, a simultaneous touch event on playing surfaces of opposing sides (e.g., 204-0 and 204-2) can generate a sound dampening, or ending event. More detailed examples of such operations will be described below.

In this way, capacitance values for sensors of multiple playing surfaces of a percussion instrument can be monitored for percussive events.

Referring now to FIG. 3, a percussion instrument according to a third embodiment is shown in a side cross sectional view, and designated by the general reference character 300. Percussion instrument 300 can include some of the same general sections as FIG. 2, thus like sections are referred to by the same reference character but with the first digit being a “3” instead of a “2”.

FIG. 3 shows an instrument having the shape of a “hi-hat” type cymbal. As is well known, a typical hi-hat cymbal arrangement includes cymbals physically positioned in opposition to one another, with one or both such cymbals being capable of moving into contact with the other to generate a sound.

In the particular example of FIG. 3, instrument 300 can include a top cymbal structure 301 that can include the same components as instrument 200. Top cymbal structure 301 can be brought down into contact with a bottom symbol structure 303. In such an arrangement, playing surface 304-2 can detect such an event to generate a sound indication. A signal path 308 can travel within a flexible wiring to enable travel of the top cymbal structure 301.

In this way, capacitance sensors can detect one part of a percussion shaped, or percussion-like object coming into contact with another part.

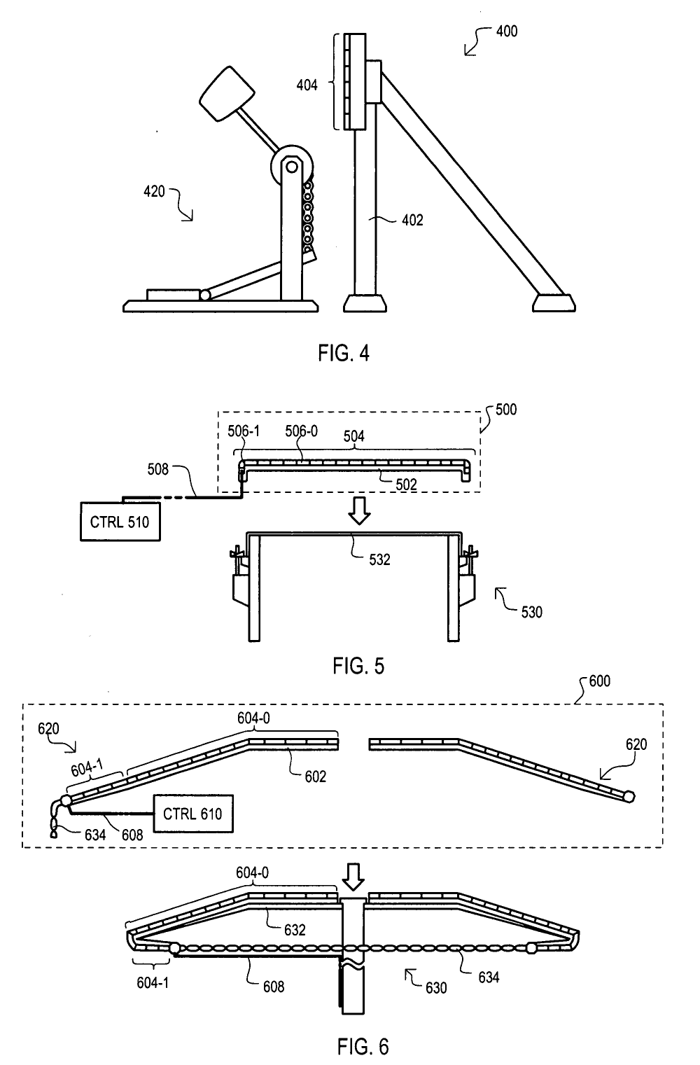

Referring now to FIG. 4, a percussion instrument according to a fourth embodiment is shown in a side cross sectional view, and designated by the general reference character 400. Percussion instrument 400 can include some of the same general sections as FIG. 1, thus like sections are referred to by the same reference character but with the first digit being a “4” instead of a “1”.

FIG. 4 shows an instrument having the shape, and general operation of a bass drum, of the type typically included with a drum kit and used in conjunction with a foot pedal. A body 402 can orient a playing surface 404 with respect to a foot pedal assembly 420, to enable playing surface 404 to be struck by a mallet of foot pedal assembly 420. A playing surface 404 can be substantially smaller in contact area than the skin area of a conventional bass drum, allowing for a more compact structure than an acoustic bass drum.

In this way, an instrument can have the same general structure of a counterpart acoustic instrument, but include a smaller playing surface area.

The above embodiments have shown arrangements in which an instrument can have a playing surface that includes capacitance sensors. While such playing surfaces can be integrated onto instruments in an essentially permanent fashion, alternate embodiments may include removable playing surfaces. Even more particularly, it may be desirable to provide playing surfaces that can be removably fixed to existing acoustic instruments. Such removable playing surfaces can provide the dual functions of (1) generating sound indications/values with capacitance sensing and (2) deadening any sound generated by the acoustic instrument.

Preferably, a removable playing surface can take the form of a mat structure that can be placed over surfaces of the acoustic instrument, enabling the mat structure to be struck in lieu of a sound generating membrane or other structure.

Two of many possible configurations are shown in FIGS. 5 and 6.

Referring now to FIG. 5, a percussion instrument having a removable capacitance sense playing surface according to a one embodiment is shown in a side cross sectional view, and designated by the general reference character 500. An instrument 500 can be shaped to conform to an acoustic playing surface of a known percussion instrument, and in the very particular example of FIG. 5, can conform to the skin (membrane) 532 of a “tom” type drum 530.

An instrument can include a playing surface 504, having one or more capacitance sensors that can provide a capacitance that can vary in response to a percussive event. Capacitance sensors (e.g., 506-0 and 506-1) can be connected by a signal path 508 to inputs of a controller assembly 510. Because instrument 500 can have a conformal shape, a signal path 508 can be a wiring that can run on an outside surface of acoustic instrument 530.

A controller assembly 510 can include the same components as controller assembly 110 described above, or other controller circuits described herein.

An instrument 500 can be fixed to an acoustic instrument 530 by any suitable mechanical method. Preferably, an instrument can include body 502 with a bottom portion that has some degree of flexibility, allowing instrument 500 to be snugly fit over a surface of acoustic instrument 530. In other arrangements, flexible bands can extend from edges of an instrument 500 that can be stretched and attached to an opposite side of the acoustic instrument. For example, in the arrangement of FIG. 5, flexible bands can be attached at one end to edge of instrument 500 and at another end to a bottom of acoustic instrument 530.

However, in arrangements in which a corresponding acoustic instrument has a playing surface oriented in a generally horizontal configuration, an instrument 500 can be placed on an acoustic playing surface 532 and remain in position due to gravity, or with a bottom surface having a grip pattern, or some combination thereof.

Referring now to FIG. 6, a percussion instrument having a removable capacitance sense playing surface according to another embodiment is shown in a side cross sectional view, and designated by the general reference character 600. FIG. 6 shows an instrument 600 that can conform to playing surfaces 632 of a cymbal 630.

A controller assembly 610 can also include the same components as controller assembly 110 described above, or other controller circuits described herein.

In the particular example of FIG. 6, instrument 600 can bend at edges 620 to wrap around an outer edge of acoustic instrument 630. Thus edges 620 can be formed of a flexible material, or have wedge shaped cut outs to conform to a smaller diameter when folded over.

An instrument 600 can be attached to a surface of the acoustic instrument according to any suitable technique. In the particular example of FIG. 6, flexible bands 634 can draw generally opposing edges 620 toward one another. Preferably, instrument 600 can be flexible and include playing surfaces 604-0 and 604-1 that can be oriented on opposing sides of acoustic instrument 630. Such a double surface can enable dampening effects, or allow instrument 600 to be included in hi-hat type cymbal configurations, or the like.

In this way, an instrument according to the embodiments can include one or more playing surfaces that can be removably fixed to existing acoustic instruments.

It is noted that removable embodiments, like those illustrated in FIGS. 5 and 6, can be played without a corresponding acoustic instrument if placed on a suitable surface.

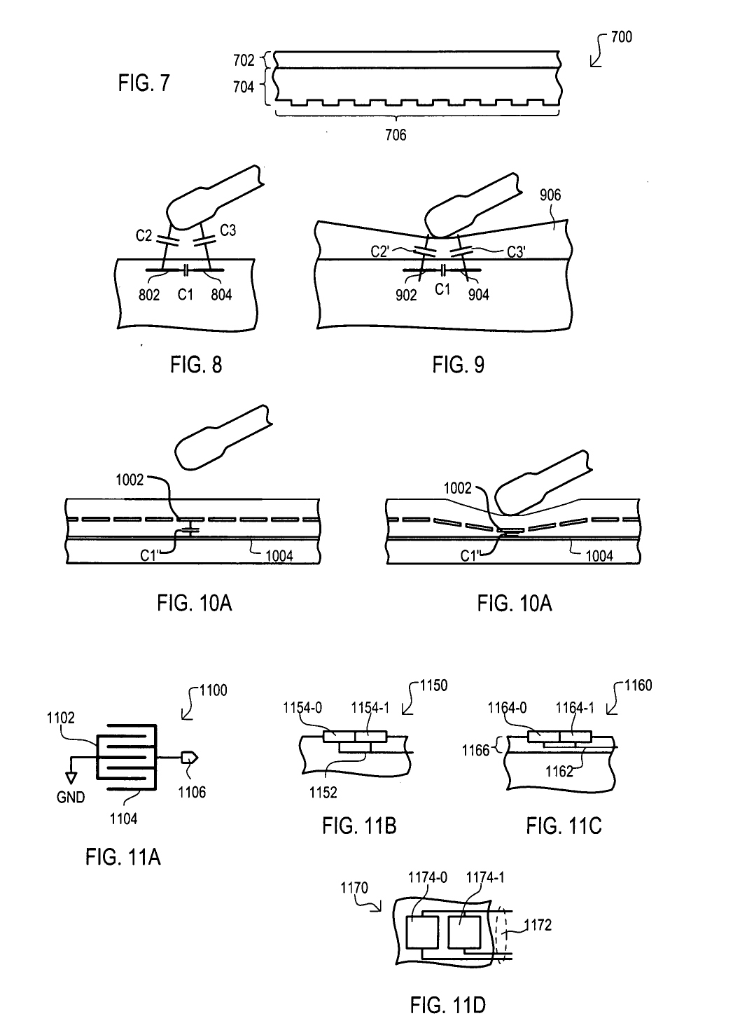

Referring now to FIG. 7, one very particular example of an instrument construction, for embodiments like those of FIGS. 5 and 6, is shown in a side cross sectional view. FIG. 7 shows a portion of an instrument 700 that includes a sensing surface 702 and a cushion surface 704. A sensing surface 702 can include capacitance sensing structures for detecting percussive events. Particular examples of such sensing structures are described in more detail below. Cushion surface 704 can be a surface that absorbs mechanical energy of a percussive event, to thereby reduce any actual sound generated by the corresponding acoustic instrument. Preferably, a cushion surface 704 can be formed from a rubber or other elastomeric material of relatively high density, and include a “grip” type pattern on a bottom surface 706.

In this way, instruments according to the present invention can include capacitance sensors formed over a cushion material for absorbing percussive strikes.

Referring now to FIG. 8, a capacitance sensor that can be utilized in the embodiments will be described. A capacitance sensor can operate by detecting a capacitance between an active switch area and an adjacent grounded area. Two conductive plates 802, 804 (or lines, or some other geometric structure), one of which is active, can have a finite capacitance C1 between them. When a conductive striking object (stick, finger or other conductive surface) is placed in close proximity, the capacitance changes, as shown by capacitance C2, C3.

In this way, capacitance sensors can detect a change in capacitance due to objects in proximity to a playing surface, to thereby detect an input event for an instrument.

Referring now to FIG. 9, another capacitance sensor configuration will be described. FIG. 9 shows an arrangement like that of FIG. 8, but with a covering material 906 that is deformable, but resilient. When an object strikes material 906, depending upon how close the object gets to plates 902 and 904, a capacitance value C2′ and C3′ can vary. Inclusion of deformable material 906 can allow a measured capacitance to vary according to force of percussive event, as the greater the force, the greater the deformation.

In this way, capacitance sensors can detect a degree of deformation, due to an object striking a playing surface, thus generating a capacitance value that can vary according to force of impact.

It is noted that arrangements like those of FIGS. 8 and 9 would include strikes of objects that are conductive, to some extent. While fingers can be suitably conductive, other normally less conductive objects, such as drumsticks, should be formed of a conductive material in order to induce a sufficiently large change in capacitance.

Referring now to FIGS. 10A and 10B, yet another capacitance sensor configuration will be described. FIGS. 10A and 10B show an arrangement like that of FIG. 9, but with conductive plates 1002, 1004 being oriented opposite to one another in a direction generally perpendicular to a playing surface. Further, a conductive plate 1002 is preferably formed of a flexible material. Prior to a percussive event, a capacitance between plates C1″ can have one value. In response to a percussive event, plates 1002, 1004 can be forced closer to one another, changing the capacitance between the plates 1002, 1004.

As in the case of FIG. 9, in the approach of FIG. 10, a degree of capacitance can reflect the amount of force in a percussive event.

Unlike the arrangements of FIG. 8 or 9, a striking object need not be generally conductive.

Referring now to FIGS. 11A to 11D, various examples of sensor wiring will now be described. FIG. 11A is diagram showing one example of a capacitance sensor 1100. A capacitance sensor 1100 can include a first plate 1102 that can be connected to one potential node (in this example ground), and a second plate 1104 that can be connected to an input node 1106. Thus, a capacitance sensed at input node 1106 can be used to determine if an input event has occurred.

Wirings can be provided to capacitive sensors according to various ways. A few possible arrangements are shown in FIGS. 11B to 11D. FIG. 11B shows a side cross sectional view of a playing surface 1150 which can include wiring formed within and connecting to each capacitance sensor (e.g., 1154-0 and 1154-1).

FIG. 11C shows a side cross sectional view of a playing surface 1160 having a circuit board 1166 containing wiring 1162 for capacitance sensors (e.g., 1154-0 and 1154-1). A circuit board 1166 can be a rigid or flexible printed circuit board.

While FIGS. 11B and 11C show arrangements in which wirings can be formed below capacitance sensors, in alternate arrangements, wirings can be situated on the sides of capacitance sensors. One such arrangement is shown in FIG. 11D.

FIG. 11D shows a top plan view of a playing surface 1170 containing capacitance sensors (e.g., 1174-0 and 1174-1). Wiring 1172 for such sensors can be disposed to one side or both sides of a sensor.

Wirings to capacitance sensors can extend to a processing section within a controller assembly, or the like, which can sense a capacitance at each such sensor or groups of sensors.

In this way, wirings can be provided from capacitance sensors to capacitance sensing circuits.

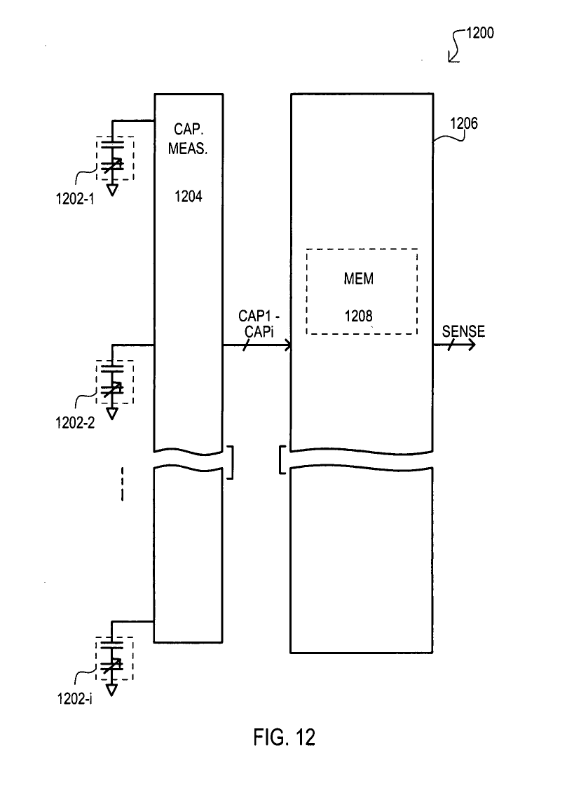

A sensing of the capacitance presented by multiple sensors on a playing surface of a percussion instrument, or percussion instrument type input device can be undertaken in various ways. One particular approach is shown in detail in FIG. 12.

Referring now to FIG. 12, a capacitance sense system according to an embodiment is shown in a block schematic diagram and designated by the general reference character 1200. As will be described in more detail below, a capacitance sense system 1200 can form part of a controller assembly, like that shown in the various embodiments herein.

A capacitance sense system 1200 can have inputs connected to a number of capacitance sensors 1202-1 to 1202-i. Each capacitance sensor (1202-1 to 1202-i) can have a capacitance that can vary depending upon mode of operation. More particularly, each capacitance sensor (1202-1 to 1202-i) can have a baseline capacitance that exists absent an input event. A baseline capacitance can be essentially constant, but can vary between capacitance sensors (1202-1 to 1202-i). In a run-time mode (i.e., a mode in which capacitance values are being actively monitored), each capacitance sensor (1202-1 to 1202-i) can be monitored to detect an input event. As but one example, each capacitance sensor (1202-1 to 1202-i) can have a run-time capacitance that will drop with respect to a baseline value in the event an object, such as a finger, is in close proximity to the sensor.

A capacitance sense system 1200 can include a capacitance sensing section 1204 and computation section 1206. A sensing section 1204 can generate capacitance values CAP1 to CAPi corresponding to each capacitance sensor (1202-1 to 1202-i).

A sensing section 1204 preferably generates numerical values as capacitance values (CAP1 to CAPi), even more preferably, generates count values based upon a charging of a capacitance sensor. A sensing section 1204 can include a sensing circuit for each input, but may preferably multiplex (MUX) inputs to a common sense node.

In the event a sensing section 1204 utilizing a charging rate of a capacitance as a measurement, a sensing section 1204 can include one or more charging sources (e.g., current sources). In particular, one charging source may be spread among capacitance sensors in a multiplexed approach, or individual charging sources may be provided to each capacitance sensor. A charging source can take any of a number of possible forms. In one simple approach, a charging source can be a resistor that is connected directly, or by way of a switching arrangement, between a capacitance sensor and a high power supply node. Alternate approaches can include current digital-to-analog converters (current DACs), or reference current sources biased according to well known temperature independent techniques (band-gap reference, etc.).

In the event a sensing section 1204 utilizes modulation (e.g., sigma-delta modulation) a sensing section 1204 can include a switched capacitor network, with modulation capacitor and other elements being shared with capacitance sensors in a multiplexed approach.

A computation section 1206 can execute predetermined arithmetic and/or logic operations. In a run-time mode, a computation section 1206 can receive run-time capacitance values (CAP1 to CAPi) corresponding to each capacitance sensor (1202-1 to 1202-i). A computation section 1206 can compare each run-time capacitance values to the corresponding baseline capacitance values. Sense results can then be compared to threshold values to determine if an input event has occurred. It is noted that capacitance values can be sensed values, or capacitance rate of change values generated by evaluating capacitance values at one or more different times.

In this way, capacitance values for a number of capacitance sensors can be sensed to determine if an input event has occurred.

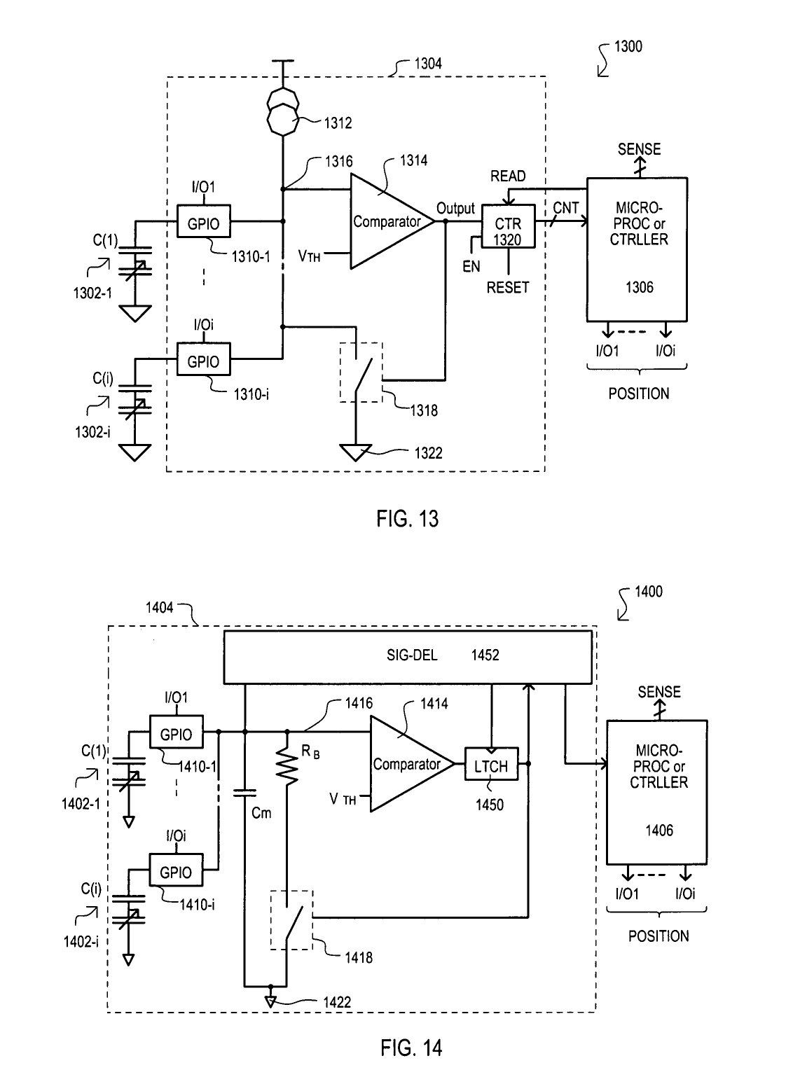

Referring now to FIG. 13, a capacitance sense system according to a second embodiment is shown in a block schematic diagram and designated by the general reference character 1300. A system 1300 can include some of the same general sections as FIG. 12, thus like sections are referred to by the same reference character, but with the first digit being an “13” instead of a “12”.

In the embodiment of FIG. 13, a sensing section 1304 can include a number of general purpose input/output (GPIO) cells 1310-1 to 1310-i, a current source 1312, a comparator 1314, a reset switch 1318, and a counter 1320. Each capacitance sensor (1302-1 to 1302-i) can be tied to a corresponding GPIO cells (1310-1 to 1310-i). Individual GPIO cells (1310-1 to 1310-i) can be connected to a common bus 1316 in a multiplexer type fashion. GPIO cells (1310-1 to 1310-i) can each be controlled by corresponding I/O signals I/O1 to I/Oi.

Current source 1312 can be connected to common bus 1316 and provide a current. Such a current can be constant current when making capacitance measurements. Preferably, current source 1312 can be programmable to accommodate variations in a sensed capacitance value. Reset switch 1318 can be connected between common bus 1316 and a low power supply node 1322. Reset switch 1318 can be controlled according to an output of comparator 1314.

Comparator 1314 can have one input connected to common bus 1316, a second input connected to a threshold voltage VTH and an output connected to reset switch 1318 and to counter 1320.

Counter 1320 can be a gated counter that can accumulate transitions at the output of comparator 1314. In particular, in response to an enable signal EN, counter 1320 can perform a counting operation. In response to a reset signal RESET, counter 1320 can reset a count value to some predetermined starting value (e.g., 0). In response to a read signal READ, counter 1320 can output an accumulated count value CNT. In one very particular arrangement, a counter 1320 can be a 16-bit timer with an externally triggered capture function.

In operation, compare section 1304 can multiplex capacitance readings by sequentially enabling (e.g., placing in a low impedance state) GPIO cells (1310-1 to 1310-i). While one GPIO cell is enabled, current source 1312 can charge the capacitance of the corresponding capacitance sensor. Once a potential at common bus 1316 exceeds voltage VTH, an output of comparator 1312 can transition from an inactive to active state, turning on reset switch 1318, thus discharging common bus 1316. The process can repeat to generate an oscillating signal at the output of comparator 1314. Such an oscillation rate can be counted by counter 1320 over a predetermined time period to generate a count value. Once a count value has been acquired from one capacitance sensor, the current GPIO cell can be disabled and a new GPIO cell enabled. The operation can then be repeated to generate count values for all capacitance sensors of interest. In this way, capacitance values can be acquired for all capacitance sensors (1302-1 to 1302-i).

A calculation section 1306 can generate position information based upon readings generated by capacitance sensors (1302-1 to 1302-i). Optionally, a calculation section 1306 can perform additional functions in the sense operation, including but not limited to acquiring baseline values (i.e., count values absent an input event) for any or all of capacitance sensors, generating correction factors for all or selected capacitance sensors to account for variations between capacitance sensors (assuming uniformity is desired) or to introduce variations in sensing functions between such sensors. A calculation section 1306 can include a microprocessor core or microcontroller that receives count values from counter 1320, and executes arithmetic operations to generate position information and other functions. In the arrangement of FIG. 13, calculation section 1306 can also output I/O signals (I/O1 to I/Oi) to control the multiplexing measurement of capacitance sensors. Such I/O signals can correspond to capacitance sensor position information.

FIG. 13 shows a relaxation oscillator method of sampling a capacitance. Alternate arrangements can utilize different methods for sensing a capacitance. One such alternate approach is shown in FIG. 14.

Referring now to FIG. 14, a capacitance sense system according to another embodiment is shown in a block schematic diagram and designated by the general reference character 1400. A system 1400 can include some of the same general sections as FIG. 13, thus like sections are referred to by the same reference character, but with the first digit being an “14” instead of a “13”.

The embodiment of FIG. 14 can differ from that of FIG. 13 in that it can use a sigma-delta modulation approach to determine a capacitance at an input sensor. Thus, a sensing section 1404 can include elements for forming an input switched capacitor network in conjunction with capacitance sensors (1402-1 to 1402-i). In the particular arrangement of FIG. 14, a sensing section 1404 can include a modulation capacitor Cm connected in parallel with a “bleed” resistor R_{B} to common bus 1416. Further, a reset switch 1418 can be connected between bleed resistor R_{B} and a low power supply node 1422. Values output from comparator 1414 can be latched in output latch 1450. Output latch 1450, in turn, can control reset switch 1418.

The embodiment of FIG. 14 can also differ from that of FIG. 13 in that a sigma-delta modulation control circuit 1452 can be included. Control circuit 1452 can generate timing control signals for controlling the operation of output latch 1450. Further, control circuit 1452 can include switching circuits for charging common bus 1416 during a sampling operation.

More detailed examples of sigma-delta modulation are shown in “Migrating from CSR to CSD”, by Ted Tsui, an Application Note published by Cypress Semiconductor Corporation, the contents of this article are incorporated by reference herein.

Of course, while the embodiments of FIGS. 13 and 14 show a microprocessor core, this represents but one type of calculation section. Alternate embodiments could be realized by an application specific integrated circuit (ASIC), microcontroller, or programmable logic device, to name but a few examples.

It is noted that multiple capacitance sensing systems, such as those shown in FIGS. 12 to 14 can be utilized in parallel, with different systems monitoring different sets of capacitance sensors. This can increase overall sensor scan speed, and hence increase the response time of a capacitance sense operation. Alternatively, multiple such capacitance sensing systems may be needed for higher resolution capacitance sensor arrays.

In addition or alternatively, a capacitance sensing system can scan subsets of the total number of capacitance sensors, to increase a scan speed over one area of an array. Even more particularly, once an input event has been detected, scan operations can be limited to a subset of capacitance sensors within a predetermined area surrounding the capacitance sensor(s) detecting the input event.

Preferably, the systems shown in FIGS. 13 and 14 can include one or more PSoC® mixed signal array made by Cypress Semiconductor Corporation of San Jose, Calif.

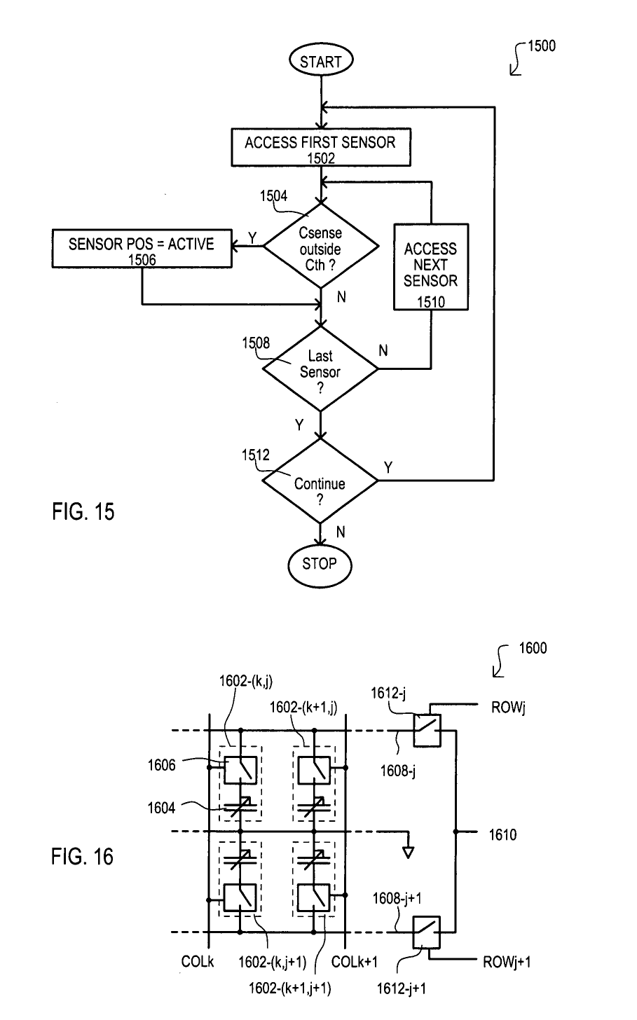

Referring now to FIG. 15, a method for sensing capacitance values is shown in a flow diagram and designated by the general reference character 1500.

A method 1500 can include accessing a first sensor (step 1502). Such a step can include activating a first capacitance sensor and/or enabling an electrical path to such a sensor. A detected capacitance for the sensor (Csense) can be compared to a threshold capacitance value (Cth) (step 1504). A threshold value (Cth) can be a single value, a range, and can be fixed or variable depending upon the particular application. In one very particular arrangement, a step 1504 can include comparing one or more count values to a threshold count value. If a measured capacitance value is outside a threshold (Y from 1504), a sensor position corresponding to the capacitance sensor can be indicated as active (step 1506).

Referring still to FIG. 15, if a measured capacitance value is not outside a threshold (N from 1504), a method can determine if a last sensor has been reached (step 1508). If a last sensor has not been reached (N from 1508), a method 1500 can access a next sensor (step 1510), and return to step 1504. If a last sensor has been reached (Y from 1508), a method 1500 can determine whether sensing operations are to continue (step 1512). If sense operations are to continue (Y from 1512), a method can return to step 1502.

It is understood that the arrangement of FIG. 15 shows but one particular embodiment. The manner by which capacitance sensors are measured (i.e., scanned) need not be in any particular order, and could be according to other criteria, including essentially random patterns.

In percussion instrument embodiments, scan rates are preferably fast enough to detect two objects (e.g., drum sticks, fingers, brushes) striking a surface that appear to a player to be essentially simultaneous. As noted above, faster scan rates can be achieved by incorporating parallel sensing circuits.

In this way, a method can sense capacitance values for multiple sensors of an instrument.

While some embodiments can provide a sensing signal path between each capacitance sensor and a sensing system, alternate arrangements can share such paths. One very particular example of such an approach is shown in FIG. 16.

Referring now to FIG. 16, a capacitance sensor array is shown in a block diagram and designated by the general reference character 1600. An array 1600 can include a number of sensor units (1602-(k,j) to 1602-(k+1,j+1)) arranged into rows and columns. Each sensor unit (1602-(k,j) to 1602-(k+1,j+1)) can be selectable according to a row signal and column signal. For example, in the particular case of FIG. 16, sensor unit 1602-(k,j) can be selected by activating signal ROWj and signal COLk.

In the particular embodiment of FIG. 16, each sensor unit can include a capacitance sensor (one shown as 1604) and a corresponding switch (one shown as 1606). A switch 1606 can be activated by a first type select signal (e.g., COLk), and thereby connect the corresponding capacitance sensor 1604 to a sense line (in this case 1606-j). Any of multiple sense lines (e.g., 1608-j and 1608-j+1) can be connected to a shared sense node 1610 by a second type select signal (e.g., ROWj, ROWj+1). In the particular example of FIG. 16, second type select signals ROW and ROWj+1 can control row switches 1612-j and 1612-j+1, respectively.

In this way, capacitance sensors of an array can be selectable in a row and/or column wise fashion. It is noted that while FIG. 16 shows an array having rows and columns, other arrangements may include but one row or one column.

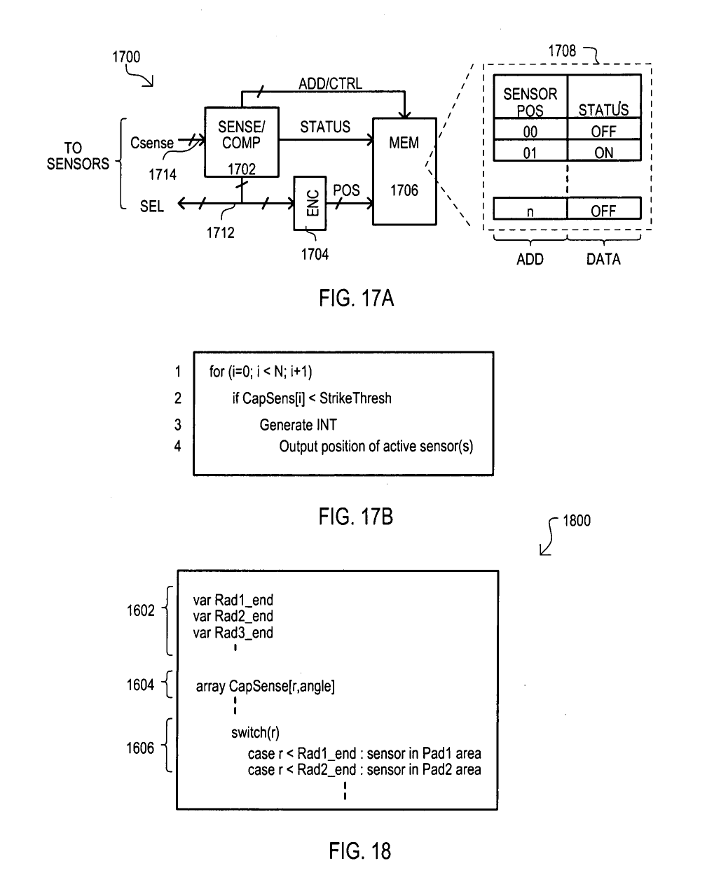

In addition to sensing capacitance values for sensors, a computation section, such as that shown as 1206, 1306 or 1406 in the above embodiments, can generate position and status information for such sensors. Status information can indicate an input event, such a percussive event on a playing surface. Two possible examples of such operations are shown in FIGS. 17A and 17B.

Referring now to FIG. 17A, a sense system according to one embodiment is shown in a block schematic and designated by the general reference character 1700. A system 1700 can include a sense and computation section 1702, an encoding section 1704, and a memory 1706. A sense and computation section 1702 can output select values SEL on select outputs 1712 to select one or more capacitance sensors. In response to such select values SEL, capacitance values Csense can be provided from such sensors to sense and computation section 1702 via sense inputs 1714. A sense and computation section 1702 can also generate one or more sensor status indications STATUS according to sense results. For example, if a capacitance value is determined to indicate an input event for a given capacitance sensor (or group of such sensors), a STATUS indication can be active. A STATUS indication(s) can be stored in a memory 1706.

An encoder 1704 can utilize select values to generate a position value POS. A position value POS can be stored in a memory 1706. Of course, a position value can be generated according to various other means. For example, a count value may be utilized to cycle through and sample each capacitance sensor (or sensor group) that is reset once all sensors have been sampled. Such a count value can be used to generate a position value (i.e., the system is known to be sampling a particular sensor at any given time).

Preferably, a memory 1706 can maintain a record of capacitance sensor status according to position. One very particular example of such an arrangement is shown as 1708. A sensor position value can be identified by an address, while a status value can be data. It is noted that a single addressable location can store the status for multiple capacitance sensors. As but one very particular example, an addressable 16-bit data value could contain the status for sensor positions 1-16, while a 16-bit value at the next sequential address could contain the status for sensor positions 17-32, etc. Such values can then be accessed to detect input events on a playing surface of an instrument.

In this way, capacitance sensor position and status values can be stored and retrieved.

While capacitance sense values can be stored, and hence reside in a passive fashion, such values can also be used for active notification of when an input event occurs. An example of such an approach is shown in FIG. 17B.

FIG. 17B is a diagram showing one approach for generating an indication when an input event is detected. FIG. 17B is described in “pseudocode,” a broad way of expressing the various steps in a method and/or functions of system. The pseudocode may be implemented into particular computer language code versions for use in a system having a general processor or specialized processor. In addition, the described method can be implemented in a higher level hardware designing language, to enable the preferred embodiment to be realized as an application specific integrated circuit (ASIC) or a portion of an ASIC, a programmable logic device, or portion of a programmable logic device.

Referring to FIG. 17B, line 1 shows a cycling through N values, where N is a number of capacitance sensors sampled. Line 2 shows a comparison step that can be performed on each capacitance value of a sensor CapSense[i]. If a sensed value falls below a given threshold StrikeThresh, an interrupt can be generated (line 3). Optionally, position information for the sensor can be output (e.g., written to a register or other storage location) (line 4).

In this way, input events can be indicated by an output signal.

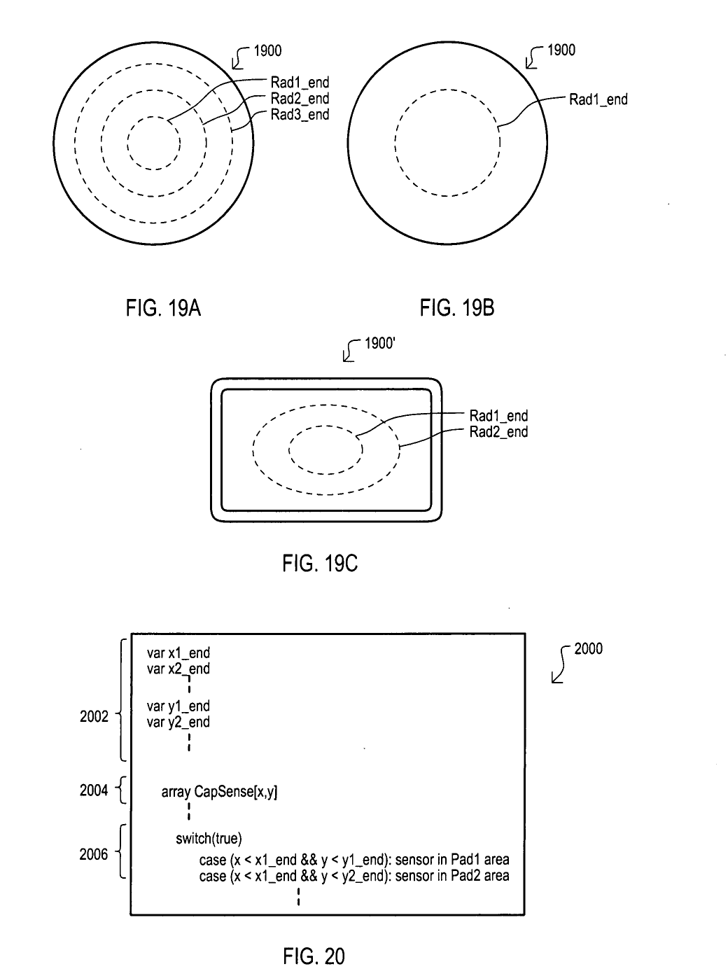

As noted above, while a capacitance array can provide position information, such position information can be programmable. As but one example, the position value provided by sensors can be grouped into sections, with a detected event at any of the sensors within a section being translated into an input event for entire section. One very particular example of such an arrangement is shown in FIGS. 18 and 19A to 19C.

FIG. 18 is a pseudocode representation 1800 showing programmability of position information. In an approach like that of FIG. 18, one or more variables can be defined that indicate partitions in an array of capacitance sensors. In the particular example show, values Rad1_end, Rad2_end, and Rad3_end can be variables selected by a user or application (see section 1802). As but one very particular example, values Rad1_end, Rad2_end, and Rad3_end can demarcate a capacitance sensor position from a central point of playing surface (i.e., according to radial position).

Referring still to FIG. 18, each capacitance sensor can be identified by an array CapSensor[r,angle] value (section 1804). Depending upon the particular array value, a capacitance sensor will be mapped to a particular section.

In the example of FIG. 18, according to an “r” value, a capacitance sensor will indicate a particular area (Pad1 to Pad3) on a playing surface (section 1806).

FIGS. 19A to 19C shows various arrangements in which capacitive sensors can be logically grouped into sections, with position information from sensors of the same section being translated into a same position value. Each of FIGS. 19A to 19C shows an example of a generally circular playing surface that can include multiple capacitance sensors, each having different coordinate values (r, angle).

FIGS. 19A and 19B show a same playing surface 1900, but with different variable values. FIG. 19A shows limits created by variables Rad1_end, Rad2_end, and Rad3_end. FIG. 19B shows limits created by the methods, but with variable Rad1_end being larger in magnitude, and variables Rad2_end, and Rad3_end being outside the values presented by capacitance sensors.

FIG. 19C shows a playing surface 1900′ that is not circular but that includes sensors having positions categorized by radial position.

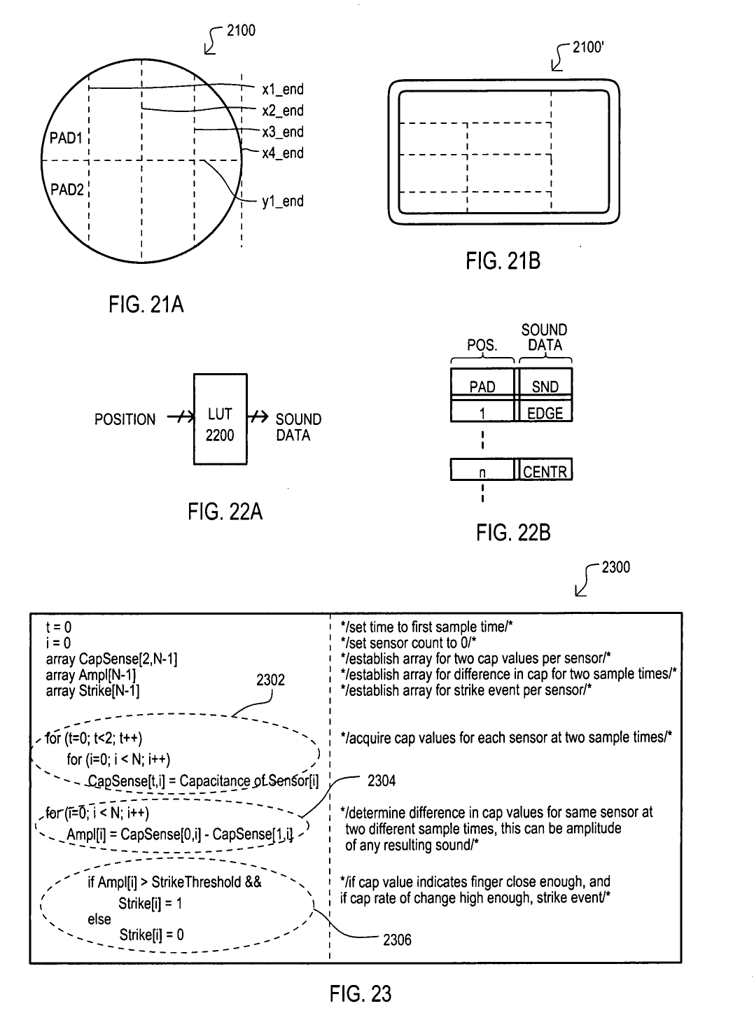

While the embodiments of FIGS. 18 to 19C show arrangements generally corresponding to a polar coordinate system, other embodiments can map capacitance sensors in a Cartesian coordinate system. Various examples of such an arrangement are shown in FIGS. 20 to 21B.

FIG. 20 shows a mapping arrangement like that of FIG. 18, but with limit variables being defined according to Cartesian values (see section 2002), and capacitance sensors being identified by an array corresponding to such values (section 2004). Depending upon the particular array value, a capacitance sensor will be mapped to a particular section (section 2006).

FIGS. 21A and 21B show two of the many possible ways in which regions can be mapped. FIG. 21A shows an example of a generally circular playing surface 2100 that can include multiple capacitance sensors, each having a different coordinate values (x,y). Regions defined by variables x1_end, x2_end, x3_end, y1_end, y2_end, and y3_end are shown in the figure.

FIG. 21B shows a playing surface 1900′ that is not circular having logical grouping of sensors according to values defining perpendicular coordinate positions.

It is understood that a very large number of different configurations can be accommodated.

In this way, capacitance sensors can be logically arranged into groups based on programmable values.

For musical production and/or digital music composition, variations in position information of capacitance sensors can be translated into variations in sound values (e.g., different tones, attack profiles, decay profiles, amplitude). Examples of such arrangements are shown in FIGS. 22A to 22B and the discussion below.

Referring now to FIG. 22A, a sound generation circuit is shown in block schematic diagram and designated by the general reference character 2200. A circuit 2200 can be a look-up table (LUT) that can receive position values, and in response thereto, output a sound value. FIG. 22B shows one very particular example of possible LUT entries. Each different pad location can index to a particular sound value.

While sound generation can be implemented with a direct indexing, such as that shown by FIGS. 22A and 22B, other approaches can calculate a sound value based on an arithmetic operation executed on input data. For example, a sound value can vary according to radial (r) position (variation from a center point of a playing surface). In one particular case, sound can be generated according to the relationship:

Sound=sound_base+position[r]*K

where “Sound” can be a resulting sound value, “sound_base” can be a baseline sound value, “position[r]” can be a radial position of a capacitance sensor receiving an input event, and “K” can be a constant.

In this way, detected input events at a capacitance sensor array can be translated into sound values that can vary according to position, where such variation can be derived by a direct indexing like approach or by a calculation based on position.

While a system can detect input events according to one or more threshold values like the approach shown in FIG. 15, in other embodiments input events can be detected based on rates of change in capacitance. When an object approaches or leaves a playing surface at a particular speed, a detected capacitance can change (e.g., suddenly drop or rise in capacitance). Such rate of change can be utilized to detect and/or categorize a given input event. One example of such an approach is shown in FIG. 23.

FIG. 23 shows an approach in pseudocode that can detect input events based on change in capacitance. Capacitance sensors can be sampled for two time periods, t=0 and t=1 (section 2302). A difference in capacitance for each capacitance sensor can be ascertained (section 2304). Such a difference can represent a change in capacitance over the time period from time t=0 to time t=1. If a capacitance change in sampled time period is sufficiently large, the input event can be indicated as being a sound generating event (section 2306).

In addition to determining whether an input event has been detected, rate of change values can also be used to determine qualities of an input. Thus, in the particular example of FIG. 23, a value in array Ampl[i] corresponding to a detected input event Strike[i]=1, can determine the quality of the event. As but a few of the many possible examples, a capacitance rate of change value (e.g., Ampl[i]) can be used to control amplitude, duration, or decay profile of a corresponding sound output value, to name but a few examples.

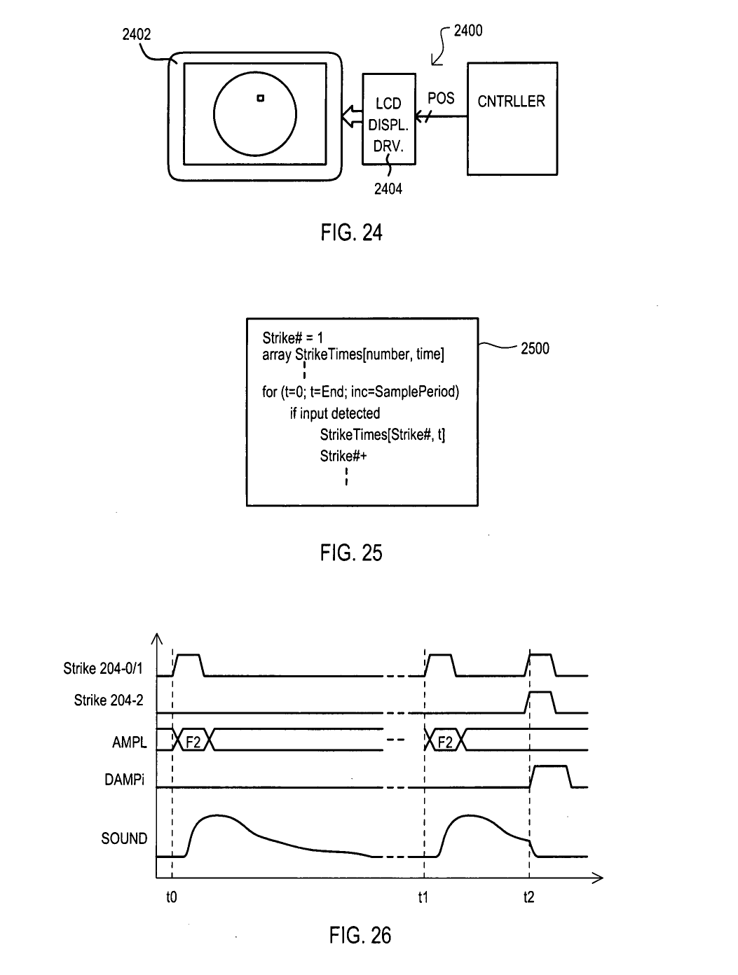

For musical instruction applications, capacitance sensors can be used to provide feedback to an instrument player. That is, during instruction, an input event can detected and provided in a visual display, or the like. An example of such an arrangement is shown in FIG. 24.

FIG. 24 shows a display system 2400 that includes a display 2402 and a display driver 2404. A display driver 2404 can produce an image on display 2402 corresponding to an instrument according to any of the various embodiments. In the particular example shown, such an image is a representation of circular playing surface. A display driver 2404 can receive position information from a computation section (e.g., 1206, 1306 or 1406) and provide an indication when an input event is detected, and display the event on display 2402.

Other embodiments directed to musical instruction or other applications can advantageously store input invents with the corresponding time at which such event occur. Such data can then be analyzed. As but two examples of the numerous possible analyses, input event and corresponding time data can be used to evaluate consistency between adjacent strikes (e.g., uniformity of beat) or rate of strikes (e.g., speed of drum roll). One very particular approach to acquiring such data is shown in FIG. 25.

FIG. 25 is a pseudocode example showing the generation of an array “StrikeTimes” that includes a time for each successive strike in a recording period. In the very particular example shown, a recording period can start at t=0 and end at t=End. Within this recording period, a playing surface (or portion thereof) can be monitored for input events at sampling rate dictated by a sampling period “SamplePeriod”. When an input event is detected, the number of the event and time at which it occurred is recorded in array StrikeTimes.

In this way, input events detected according to the various embodiments can be represented on a visual display, or recorded for analysis.

As noted above, while input events can indicate sound generating actions, such events can also indicate sound modification, or termination events. One particular example of such an arrangement will now be described with reference to FIGS. 2 and 26.

FIG. 26 is a timing diagram showing a damping operation for percussion instrument 200 shown in FIG. 2. FIG. 26 shows various waveforms: “Strike 204-0/1”, “Strike 204-2”, “AMPL”, “DAMPi” and “SOUND”.

“Strike 204-0/1” can be a signal that is activated (goes high in this example) in response to an input event being detected on playing surfaces 204-0 or 204-1 of instrument 200. “Strike 204-2” can be a signal that is activated in response to an input event being detected on playing surface 204-2. “AMPL” can be an amplitude value generated in response to an input event. As but two possible examples, a value AMPL can vary according to the rate of change in the capacitance, or can be based on the actual capacitance detected. “DAMPi” can be a signal that is activated when a damping event has been detected (described in more detail below). SOUND can be a sound value generated in response to an input event.

At time t0, a valid input event is detected in playing surface 204-0 and/or 204-1, resulting in signal Strike 204-0/1 being activated. In addition, an amplitude value (in this case F2(hex)) can be generated corresponding to the event. In response to signal Strike 204-0/1 and value AMPL, value SOUND can be generated. As shown in the figure, SOUND has a predetermined decay profile, falling off in amplitude over time.

At time t1, another valid input event occurs, that results the same generated sound values. However, at time t2, input events are detected at playing surface 204-2 and 204-0 or 204-1, at essentially the same time. Such an event can result in the activation of signal DAMPi. In response to signal DAMPi, a sound generated in response to a previous strike can be dampened. This is illustrated by the reduction in amplitude of value SOUND in response to the activation of signal DAMPi.

In this way, simultaneous inputs at different playing surfaces, or different sections of a same playing surface can be used to alter a sound value generated in response to a preceding input event.

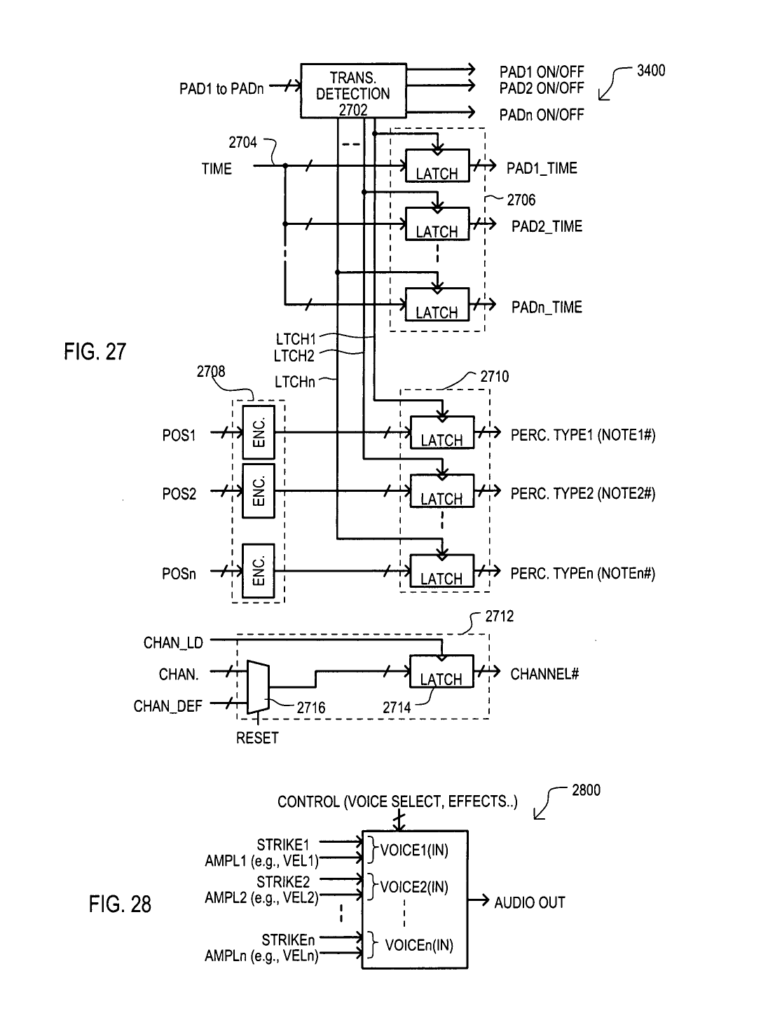

Input events generated according to the various embodiments can be encoded into particular formats for use with digital music production and composition. One particular example of such an arrangement is shown in FIG. 27.

FIG. 27 shows a digital music format encoding circuit 2700 according to one embodiment. An encoding circuit 2700 can include a transition detector 2702, a timer input 2704, one or more time latches 2706, a note encoder section 2708, and one or more note latches 2710. A transition detector 2702 can receive sound activation values PAD1 to PADn. When a sound activation value transitions from one state to another, transition detector 2702 can change a corresponding digital on/off value (PAD1_ON/OFF to PADn_ON/OFF). In addition, a transition detector 2702 can activate a corresponding latch control signal (LTCH1 to LTCHn). It is noted that a latch control signal (LTCH1 to LTCHn) can be activated according to detected transitions (i.e., activated on on-to-off transitions, as well as off-to-on transitions).

A counter input 2704 can receive a timer value TIME that indicates a time reference value in a digital music system. Time latch(es) 2710 can include a latch corresponding to each sound activation value (PAD1_ON/OFF to PADn_ON/OFF). Each such latch can latch timer value TIME in response to its corresponding sound activation value (PAD1_ON/OFF to PADn_ON/OFF). Thus, a time value can be latched in response to the activation and deactivation indication.

An encoder section 2708 can receive position values (POS1 to POSn) generated in response to capacitance values derived from sensors in a percussion instrument playing surface. In particular embodiments, position values can be generated according to the above described techniques. An encoder section 2708 can encode position values into digital note values (PERC_TYPE1 to PERC_TYPEn).

Note latch(es) 2708 can include a latch corresponding to each encoded digital note value. In a similar fashion to time latch(es) 2706, each note latch can latch its corresponding digital note value in response to its corresponding sound activation value (PAD1_ON/OFF to PADn_ON/OFF). Thus, a note values can be latched in response to the activation and deactivation indication.

In some digital music formats, percussion instruments can be assigned a predetermined channel number. Thus, it may be desirable to provide a predetermined channel number, or have such a channel number default to a given value. For this reason, an encoding circuit 2700 can optionally include a channel value section 2712.

Channel value section 2712 can include a channel latch 2714 and multiplexing type circuit 2716. A channel latch 2714 can be loaded with a channel value (CHAN.) or a default channel value (CHAN_DEF) according to a mode signal RESET. A channel value CHAN. may be selectable by a user, while a default channel value CHAN_DEF can be a hardwired value, or value stored by some other nonvolatile means. A default channel value CHAN_DEF can have a value corresponding to percussion instruments in a defined digital music standard. For example, a default channel value CHAN_DEF can be “9” in a range staring at 0, or “10” in a range staring at 1, for encoding according to the Musical Instrument Digital Interface (MIDI).

In this way, sound activation values and capacitance sensor position values can be encoded into a digital format that includes percussion type values (e.g., note numbers), as well as the time at which such notes are turned on or off.

While an embodiment like that of FIG. 27 can encode sound values and sound activation values into a predetermined digital form, other embodiments can utilize such values for the generation of an analog sound signal. An example of one such approach is shown in FIG. 28.

Referring now to FIG. 28, a sound generation circuit according to one embodiment is shown in a block schematic diagram and designated by the general reference character 2800. A sound generation circuit 2800 can be a polyphonic music synthesizer having multiple voices, each different voice being controlled, at least in part, according a sound activation value (STRIKE1 to STRIKEn). The particular example of FIG. 28 shows voice values that can also be controlled according to an amplitude value (AMPL1 to AMPLn). An amplitude value can be generated according to the various methods noted above. In many existing synthesizer designs, an amplitude value can be provided as a velocity input (VEL1 to VELn) for a given voice.

In some embodiments, an encoder section, like that shown as 2708 in FIG. 27, can be included to encode position values into particular formats compatible with a given sound generation circuit. A sound generation circuit 2800 can receive other control input values CONTROL for determining the type of voice generated by activation/position combinations.

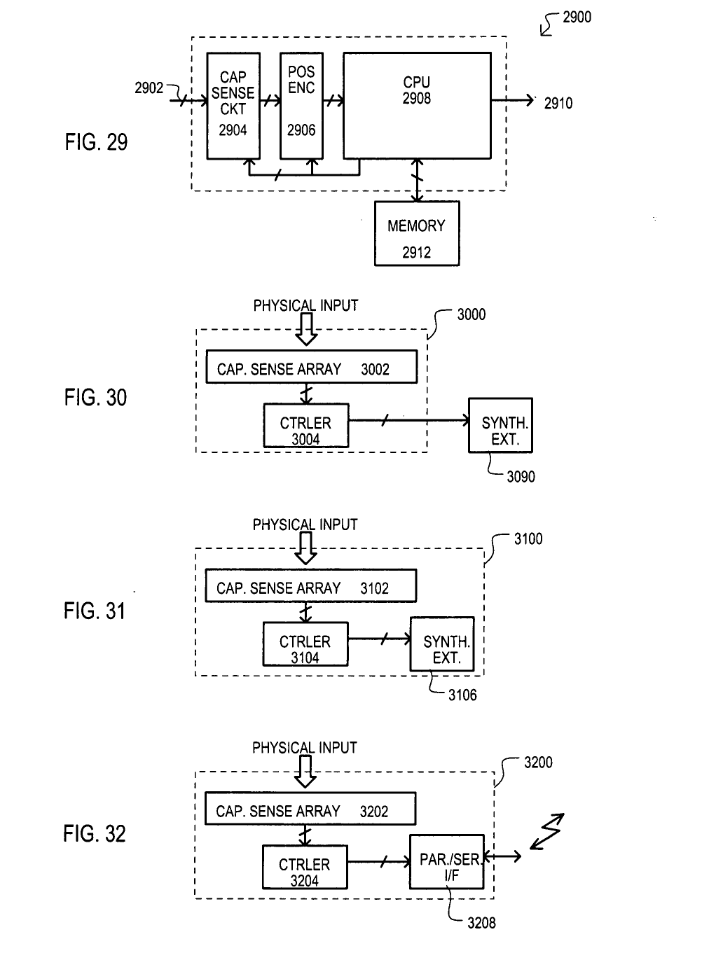

Referring now to FIG. 29, a controller system according to an embodiment is shown in a block schematic diagram and designated by the general reference character 2900. A controller system 2900 can include a number of capacitance sense inputs 2902, a capacitance sense circuit 2904, a position encoder 2906, a central processing unit (CPU) 2908, and a sound value output 2910. Capacitance sense inputs 2902 can be configured to receive inputs from capacitance sensors formed on one or more playing surfaces of a percussion instrument, or similar device.

A capacitance sense circuit 2904 can receive capacitance sense input values, and in response thereto, generate sensor activation signals. A capacitance sense circuit 2904 can evaluate capacitance values utilizing including, but not limited to, relaxation oscillator methods and sigma delta modulation methods.

A position encoder 2906 can generate position values from sensor activation signals produced by a capacitance sense circuit 2904. Such position information values can be provided to, or read from, a central processing unit (CPU) 2908.

CPU 2908 can execute predetermined instructions stored within internal memory, or optionally, in an external memory 2912. According to position values received from position encoder 2906, CPU 2910 can generate output values at sound output 2910, as well as provide control signals to the other portions of the controller system 2900.

Preferably, a controller system 2900 can include a PSoC® mixed signal array made by Cypress Semiconductor Corporation of San Jose, Calif., configured to include at least the capacitance sense circuit 2908.

In this way, the embodiments can include a system configured to generate sound values based on capacitance sense inputs of a percussion instrument, or similar device.

Various embodiments represented as systems will now be described.

Referring now to FIG. 30, a system according to one embodiment is shown in a block schematic diagram and designated by the general reference character 3000. A system 3000 can include a capacitance sensor array 3002 and a controller 3004. A capacitance sensor array 3002 can include a number of capacitance sensors, preferably situated in a playing surface of a percussion instrument.

A controller 3004 can generate sound values based on sensed capacitance values of capacitance sensor array 3002. In very particular embodiments, a controller 3004 can include any of the circuits and function described above in conjunction with FIGS. 12-15, 17A-20, and 22A-29.

The particular system 3000 can be compatible with a sound synthesizer 3090 external to the system 3006. A sound synthesizer 3090 can generate sound waveforms in response to sound values received from controller 3004. In one very particular example, a system 3000 can transmit data in MIDI format, with sound synthesizer being a MIDI compatible instrument.

A system according to another embodiment is shown in a block schematic diagram in FIG. 31, and designated by the general reference character 3100. A system 3100 can include the same general sections as that of FIG. 30, thus like sections are referred to by the same reference character but with the first two digits being “31” instead of “30”. System 3100 can differ from that of FIG. 30 in that a sound synthesizer 3108 can be included within the system 3100. Thus, a system 3100 can output an audio signal. As but one example, such an audio signal can be an analog audio signal.

A system according to yet another embodiment is shown in a block schematic diagram in FIG. 32, and designated by the general reference character 3200. A system 3200 can include the same general sections as that of FIG. 30, thus like sections are referred to by the same reference character but with the first two digits being “32” instead of “30”. System 3200 can differ from that of FIG. 30 in that it can include a parallel-to-serial interface 3208.

A parallel-to-serial interface 3208 can receive sound data values from a controller 3204, and convert such values into a serial data stream for transmission on a wire, or in a wireless fashion.

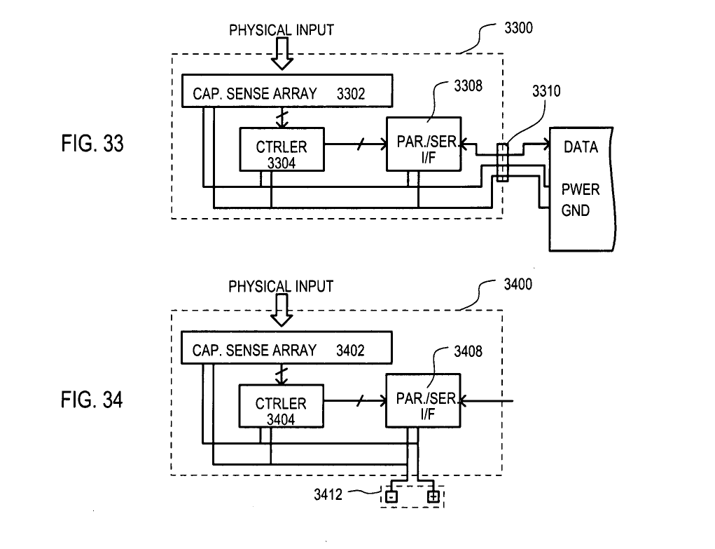

Systems and system components according to the various embodiments described above can form part of a DC powered system that receives power from a conventional AC/DC converter. However, other embodiments can have different power supply arrangements. Two such embodiments are shown in FIGS. 33 and 34.

FIG. 33 shows a system according to an embodiment that is designated by the general reference character 3300. A system 3300 can include the same general sections as that of FIG. 32, thus like sections are referred to by the same reference character but with the first two digits being “33” instead of “32”. System 3300 can differ from that of FIG. 32 in that it can include a connector 3310 suitable for attachment to a cable having both data and power wirings. Thus, a system 3300 can receive power on the cable to which it transmits data. Such an arrangement can enable a system 3300 to be connected according to various personal computer peripheral interfaces as well as gaming console interfaces. Of course, while FIG. 33 shows an arrangement in which data can be transmitted (and optionally received) in serial format, other embodiments can include parallel data transmission.

An arrangement like that of FIG. 33 may be particularly suitable as a controller device for a PC or gaming console. In such an arrangement, a parallel-to-serial interface 3408 can provide serial data in appropriate format/protocols

FIG. 34 shows a system according to a further embodiment designated by the general reference character 3400. A system 3400 can include the same general sections as that of FIG. 32, thus like sections are referred to by the same reference character but with the first two digits being “34” instead of “32”. System 3400 can differ from that of FIG. 32 in that it can include a battery connector 3412. A battery connector 3412 can have inputs suitable for connecting to a battery. Optionally, a battery connector 3412 can also have additional inputs suitable for a DC/DC or AD/DC converter. In such an arrangement, a parallel-to-serial interface 3408 is preferably a wireless transmitter/receiver.

Embodiments of the present invention are well suited to performing various other steps or variations of the steps recited herein, and in a sequence other than that depicted and/or described herein.

For purposes of clarity, many of the details of the various embodiments and the methods of designing and manufacturing the same that are widely known and are not relevant to the present invention have been omitted from the following description.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

It is also understood that the embodiments of the invention may be practiced in the absence of an element and/or step not specifically disclosed. That is, an inventive feature of the invention can be elimination of an element.

Accordingly, while the various aspects of the particular embodiments set forth herein have been described in detail, the present invention could be subject to various changes, substitutions, and alterations without departing from the spirit and scope of the invention.

What is claimed is:

1. An electronic system for generating percussion related data based on capacitive sensed inputs, comprising:
at least one capacitance sensor input configured to connect to at least one capacitance sensor, the capacitance sensor being formed in at least a first surface configured to receive percussive inputs; and
a control section coupled to the at least one capacitance sensor input that generates at least one sense indication in response to changes in a sensed capacitance, the control section including
a sense node coupled to the at least one capacitance sensor input,
at least one comparator having a first input coupled to a sense node and a second input coupled to a threshold voltage source, and
a switch circuit having a controllable impedance path coupled between the sense node and a power supply node and a switch control node coupled to the output of the at least one comparator.

2. The electronic system of claim 1, wherein:
the at least one capacitance sensor input includes a plurality of capacitance sensor inputs; and
the control section is coupled to the plurality of capacitance sensor inputs, and generates sense indication values for each capacitance sensor input, the sense indication values including position information that varies according to capacitance sensor input.

3. The electronic system of claim 1, wherein:
the control section further includes a counter having an input coupled to the output of the comparator that generates a value that varies according to a sensed capacitance at the at least one a capacitance sensor input.

4. The electronic system of claim 1, wherein:
the at least one capacitance sensor input includes a plurality of capacitance sensor inputs, the capacitance sensor inputs being logically divided into groups of capacitance sensors; and
the control section generates a position value for each sensor of a same group of capacitance sensors, the position value differing between different groups.

5. The electronic system of claim 4, wherein:
the logical division of the capacitance sensors is programmable, allowing the capacitance sensors for each group to be varied according to group limit values.

6. The electronic system of claim 4, further including:
a sound value generator coupled to receive position values, the sound value generator generating a sound value the varies according to received position value.

7. The electronic system of claim 6, wherein:
the sound value generator comprises a look-up table that stores sound values corresponding to predetermined position values.

8. The electronic system of claim 6, further including:
the control section includes a processor circuit; and
the sound value generator includes machine readable media storing instructions executable by the processor, the instructions including a sound value generator section that generates a pitch value based on adding a base sound value to an adjustment value, the adjustment value varying according to a position value.

9. The electronic system of claim 4, wherein:
the control section further includes an encoding section having
a note on/off encoder that outputs a note on/off indication in response to the at least one sense indication, and
a note number encoder that outputs a note number value in response to at least a received position value.

10. The electronic system of claim 1, wherein:
the at least one capacitance sensor input includes a plurality of capacitance sensor inputs; and
the control section includes an input switch coupled between each capacitance sensor input and the sense node.

11. The electronic system of claim 1, wherein:
the at least one sense indication generated by the control section varies according to the rate at which the sensed capacitance changes at the at least one capacitance sensor input.

12. The electronic system of claim 1, further including:
the at least first surface includes a deformable resilient layer formed over at least one capacitance sensor coupled to the at least on capacitance sensor input, the at least one capacitance sensor generating a capacitance value that varies according to a degree of deformation in the deformable resilient layer; and
the at least one sense indication generated by the control section varies according to the amount of sensed capacitance at the at least one capacitance sensor.

13. The electronic system of claim 1, wherein:
the at least one capacitance sensor input includes at least two different capacitance sensor inputs; and
the control section further includes a dampen signal generator circuit that activates a dampen signal in response to touch inputs being sensed on at least the two different surfaces, the dampen signal altering a sound value generated in response to a previously received percussive input.

14. The electronic system of claim 1, further including:
a sound synthesizer section coupled to receive the at least one sense indication from the control section and generate an audio signal therefrom.

15. The electronic system of claim 1, wherein:
the control section further includes channel identifier circuit that provides a default channel number value corresponding to a percussion instrument of a digital instrument standard.

16. The electronic system of claim 1, wherein:
the control section further includes a parallel-to-serial converter that generates a serial data output value in response to the at least one sense indication.

17. The electronic system of claim 16, wherein:
the parallel-to-serial converter includes a wireless transceiver for transmitting the serial data output values over a wireless connection.

18. The electronic system of claim 1, further including:
the electronic system is housed within a controller device; and
a physical connector for receiving a wiring external to the controller device, the connector having at least one data output and at least one power supply input coupled to at least the control section.

19. The electronic system of claim 1, wherein:
the electronic system is housed within a controller device; and
a physical connector for having power supply inputs suitable for connection with a battery.

20. A percussion instrument data generating system, comprising:
a plurality of capacitance sensors coupled to at least a first surface;
a controller section that includes
a plurality of switches for selectively connecting each capacitance sensor to a sense node,
a capacitance sense circuit coupled to the sense node that measures capacitance presented at the sense node, and
an encoder section that generates a position value for a sensed input event that varies according to at least which capacitance sensor detects the input event.

21. The system of claim 20, wherein:
the at least first surface is formed on a top side of a cymbal shaped object.

22. The system of claim 21, wherein:
at least a second surface formed on a bottom side of the cymbal shaped object opposite to the top side; and
the plurality of capacitance sensors includes at least one capacitance sensor coupled to the second surface.

23. The system of claim 20, wherein:
the at least first surface is formed on a top side of a drum shaped object.

24. The system of claim 20, wherein:
the at least first surface is removable from and attachable to a percussion instrument shaped object.

25. The system of claim 20, wherein:
the at least first surface is formed in a standable structure in a position alignable to be struck by a hammer of a bass drum foot pedal, the at least first surface being smaller than bass drum membrane area.

26. A percussion instrument system, comprising:
a playing surface configured to receive percussive events that includes a plurality of capacitance sensors; and
a controller section coupled to the playing surface that includes
a plurality of switches for selectively connecting each capacitance sensor to a sense node, and
an encoder section that generates a position value for a sensed input event that varies according to at least which capacitance sensor detects the input event.

27. The system of claim 26, wherein:
the playing surface comprises a capacitance sensing layer that includes the capacitance sensors and an absorbing layer formed of a resilient material for absorbing mechanical energy from received percussive events.

28. The system of claim 26, wherein:
the playing surface can be removably fixed onto a surface of an acoustic percussion instrument.

29. The system of claim 26, wherein:
the playing surface includes a flexible edge portion configured to compressively attach to outer edges of an acoustic percussion instrument.
